(19) United States
(12) Patent Application Publication
(10) Pub. No.: US 2006/0123401 A1
(43) Pub. Date: Jun. 8, 2006

(54) Method and system for exploiting parallelism on a heterogeneous multiprocessor computer system

(75) Inventors: John Kevin Patrick O'Brien, South Salem, NY (US); Kathryn M. O'Brien, South Salem, NY (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 11/002,555

(22) Filed: Dec. 2, 2004

(51) Int. Cl. G06F 9/44

(52) U.S. Cl. 717/131

(57) ABSTRACT

In a multiprocessor system it is generally assumed that peak or near peak performance will be achieved by splitting computation across all the nodes of the system. There exists a broad spectrum of techniques for performing this splitting or parallelization, ranging from careful handcrafting by an expert programmer at the one end, to automatic parallelization by a sophisticated compiler at the other. This latter approach is becoming more prevalent as the automatic parallelization techniques mature. In a multiprocessor system comprising multiple heterogeneous processing elements these techniques are not readily applicable, and the programming complexity again becomes a very significant factor. The present invention provides for a method for computer program code parallelization and partitioning for such a heterogeneous multi-processor system. A Single Source file, targeting a generic multiprocessing environment is received. Parallelization analysis techniques are applied to the received single source file. Parallelizable regions of the single source file are identified based on applied parallelization analysis techniques. The data reference patterns, code characteristics and memory transfer requirements are analyzed to generate an optimum partition of the program. The partitioned regions are compiled to the appropriate instruction set architecture and a single bound executable is produced.

### CROSS-REFERENCED APPLICATIONS

This application relates to co-pending U.S. patent application entitled SOFTWARE MANAGED CACHE OPTIMIZATION SYSTEM AND METHOD FOR MULTI-PROCESSING SYSTEMS (Docket No. AUS920040405US1), filed concurrently herewith.

### TECHNICAL FIELD

The present invention relates generally to the field of computer program development and, more particularly, to a system and method for exploiting parallelism within a heterogeneous multi-processing system.

### BACKGROUND

Modern computer systems often employ complex architectures that can include a variety of processing units, with varying configurations and capabilities. In a common configuration, all of the processing units are identical, or homogeneous. Less commonly, two or more non-identical or heterogeneous processing units can be used. For example, in Broadband Processor Architecture (BPA), the differing processors will have instruction sets, or capabilities that are tailored specifically for certain tasks. Each processor can be more apt for a different type of processing and in particular, some processors can be inherently unable to perform certain functions entirely. In this case, those functions must be performed, when needed, on a processor that is capable of their performance, and optimally, on the processor best fitted to the task, if doing so is not detrimental to the performance of the system as a whole.

Typically, in a multiprocessor system, it is generally assumed that peak or near peak performance will be achieved by splitting computational loads across all the nodes of the system. In systems with heterogeneous processing units, the different types of processing nodes can complicate allocation of computational and other loads, but can potentially yield better performance than homogeneous systems. It will be understood to one skilled in the art that the performance tradeoffs between homogeneous systems and heterogeneous systems can be dependent on the particular components of each system.

There are many techniques for splitting computational or other loads, often referred to as “parallelization,” ranging from careful handcrafting by an expert programmer to automatic parallelization by a sophisticated compiler. Automatic parallelization is becoming more prevalent as these techniques mature. However, modern automatic parallelization techniques for multiprocessor systems with multiple heterogeneous processing elements are not readily available, which also increases the programming complexity. For example, in Broadband Processor Architecture (BPA) systems, in order to reach achievable performance, an application developer, that is, the programmer, must be very knowledgeable in the application, must possess a detailed understanding of the architecture, and must understand the commands and characteristics of the system's data transfer mechanism in order to be able to partition the program code and data in such a way as to attain optimal or near optimal performance. In BPA systems in particular, the complexity is further compounded by the need to target two distinct ISAS, and so the task of programming for high performance becomes extremely labor intensive and will reside in the realm of the very specialized application programmers.

However, the utility of a computer system is achieved by the process of executing specially designed software, herein referred to as computer programs or codes, on the processing unit(s) of the system. These codes are typically produced by a programmer writing in a computer language and prepared for execution on the computer system by the use of a compiler. The ease of the programming task, and the efficiency of the ultimate execution of the code on the computer system are greatly affected by the facilities offered by the compiler. Many modern simple compilers produce slowly executing code for a single processor. Other compilers have been constructed that produce relatively extremely rapidly executing code for one or more processors in a homogeneous multi-processing system.

In general, to prepare programs for execution on heterogeneous multi-processing systems, typical modern systems require a programmer to use several compilers and laboriously combine the results of these efforts to construct the final code. To do this, the programmer must partition his source program in such a way that the appropriate processors are used to execute the different functionalities of the code. When certain processors in the system are not capable of executing particular functions, the program or application must be partitioned to perform those functions on the specific processor that offers that capability.

This functional partitioning alone, however, will not achieve peak or near peak performance of the whole system. In heterogeneous systems such as the BPA, optimal performance is attained by two or more identical processors within the overall heterogeneous system operating in parallel on a given portion or subtask of a program or application. Clearly, the expert programmer needs to add parallelization techniques to the set of skills necessary to extract performance from the heterogeneous parallel processor, and this will further increase the complexity of the task. Frequently, systems such as described are sufficiently powerful that tradeoffs can be made between the skill needed to achieve optimal performance, and the time needed to hand craft such an optimally partitioned and parallelized application. In the rapid prototyping stage of development, the time needed to create an application will often be as important as the execution time of the finished application.

Therefore, there is a need for a system and/or method for computer program partitioning and parallelizing for heterogeneous multi-processing systems that addresses at least some of the problems and disadvantages associated with conventional systems and methods.

### SUMMARY OF THE INVENTION

The present invention provides for a method for computer program code partitioning and parallelizing for a heterogeneous multi-processor system by means of a ‘Single Source Compiler.’ One or more source files are prepared for execution without reference to the characteristics or number of the underlying processors within the heterogeneous multiprocessing system. The compiler accepts this single source file and applies the same analysis techniques as it would for automatic parallelization in a homogeneous multiprocessing environment, to determine those regions of the program that may be parallelized. This information is then input to the whole program analysis, which examines data reference patterns and code characteristics to determine the optimal partitioning/parallelization strategy for the particular program on the distinct instruction sets of the underlying architecture. The advantage of this approach is that it frees the application programmer from managing the complex details of the architecture. This is essential for rapid prototyping but may also be the preferred method of development for applications that do not require execution at peak performance. The single source compiler makes such heterogeneous architectures accessible to a much broader audience.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a computer program code partitioning and parallelizing system; and

FIG. 2 is a flow diagram depicting a computer program code partitioning and parallelizing method.

### DETAILED DESCRIPTION

Herein we disclose a method of compilation that extends existing parallelization techniques for homogeneous multiprocessors to a heterogeneous multiprocessor of the type described above. In particular, the processor we target comprises a single main processor and a plurality of attached homogeneous processors that communicate with each other either through software simulated shared memory (such as, for example, associated with a software-managed cache) or through explicit data transfer commands such as DMA. The novelty of this method lies, in part, in that it permits a user to program an application as if for a single architecture and the compiler, guided either by user hints or using automatic techniques, which will take care of the program partitioning at two levels: it will create multiple copies of segments of the code to run in parallel on the attached processors, and it will also create the object to run on the main processor. These two groups of objects will be compiled as appropriate to the target architecture(s) in a manner that is transparent to the user. Additionally the compiler will orchestrate the efficient parallel execution of the application by inserting the necessary data transfer commands at the appropriate locations in the outlined functions. Thus, this disclosure extends traditional parallelization techniques in a number of ways.

Specifically, we consider, in addition to the usual data dependence issues, the nature of the operations considered for parallelization and their applicability to one or another of the target processors, the size of the segments to be outlined for parallel execution, and the memory reference patterns, which can influence the composition or ordering of segments for parallel execution. In general, the analysis techniques do not consider that the target processors are non-homogeneous; this information is incorporated into the heuristics applied to the cost model. Knowledge of the target architecture becomes apparent only in the later phase of processing when an architecture specific code generator is invoked. As used herein, “Single Source or Combined” compiler generally refers to the subject compiler, so named because it replaces multiple compilers and Data Transfer commands and allows the user to present a “Single Source”. As used herein, “Single Source” means a collection of one or more language-specific source files that optionally contain user hints or directives, targeted for execution on a generic parallel system.

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

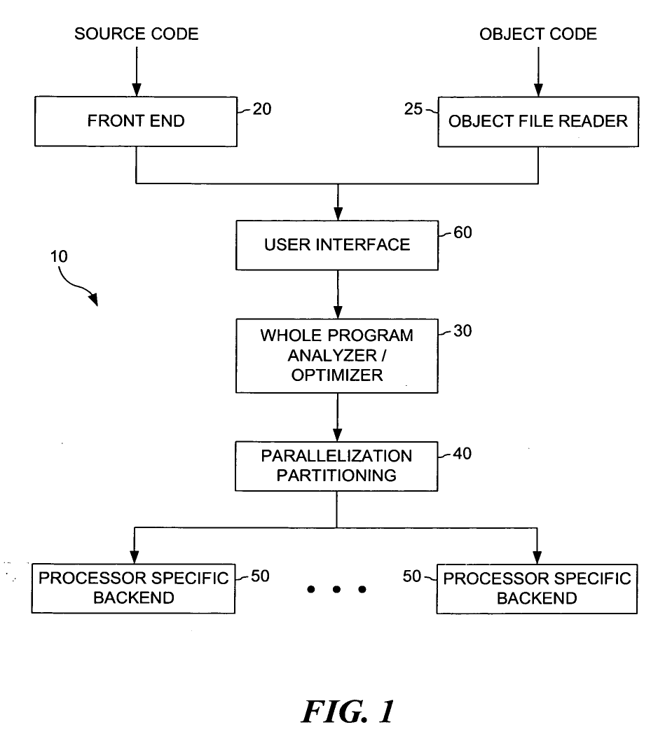

Referring to FIG. 1 of the drawings, the reference numeral 10 generally designates a compiler, such as the Single Source compiler described herein. It will be understood to one skilled in the art that the alternative to the method described herein would typically require two distinct such compilers, each specifically targeting a specific architecture. Compiler 10 is a circuit or circuits or other suitable logic and is configured as a computer program code compiler. In a particular embodiment, compiler 10 is a software program configured to compile source code into object code, as described in more detail below. Generally, compiler 10 is configured to receive language-specific source code, optionally containing user provided annotations or directives, and optionally applying user-provided tuning parameters provided interactively through user interface 60, and to receive object code through object file reader 25. This code will subsequently pass through whole program analyzer and optimizer 30, and parallelization partitioning module 40, and ultimately to the processor specific back end code module(s) 50, which generates the appropriate target-specific set of instructions, as described in more detail below.

In particular, in the illustrated embodiment, compiler 10 contains a language specific source code processor (front end) 20. Front End 20 contains a combination of user provided “pragmas” or directives and compiler option flags provided through the command line or in a makefile command or script. Additionally, complier 10 includes user interface 60. User interface 60 is a circuit or circuits or other suitable logic and is configured to receive input from a user, typically through a graphical user interface. User interface 60 provides a tuning mechanism whereby the compiler feeds back to the user based on its analysis phase, problems or issues impeding the efficient parallelization of the program, and provides the user the option of making minor adjustments or assertions about the nature or intended use of particular data items.

Compiler 10 also includes object file reader module 25. Object file reader module 25 is a circuit or circuits or other suitable logic and is configured to read object code and to identify particular parameters of the computer system on which compiled code is to be executed. Generally, object code is the saved result of previously processing source code received by front end code module 20 through compiler 10 and storing information about said source code derived by analysis in the compiler. In a particular embodiment, object file reader module 25 is a software program and is configured to identify and map the various processing nodes of the computer system on which compiled code is to be executed, the “target” system. Additionally, object file reader module 25 can also be configured to identify the processing capabilities of identified nodes.

Compiler 10 also includes whole program analyzer and optimizer module 30. Whole program analyzer and optimizer module 30 is a circuit or circuits or other suitable logic, which analyzes received source and/or object code, as described in more detail below. In a particular embodiment, whole program analyzer and optimizer module 30 is a software program, which creates a whole program representation of received source and/or object code with the intention of determining the most efficient parallel partitioning of said code across a multiplicity of identical synergistic processors within a heterogeneous multi-processing system. A side effect of such analysis is the identification of node-specific segments of said computer program code. Thus, generally, whole program analyzer and optimizer module 30 can be configured to analyze an entire computer program source code, that is, received source or object code, with possible user modifications, to identify, with the help of user provided hints, segments of said source code that can be processed in parallel on a particular type of processing node, and to isolate identified segments into subroutines that can be subsequently compiled for the particular required processing node, the “target” node. In one embodiment, the whole program analyzer and optimizer module 30 is further configured to apply automatic parallelization techniques to received source and/or object code. As used herein, an entire computer program source code is a set of lines of computer program code that make up a discrete computer program, as will be understood to one skilled in the art.

In particular, in one embodiment, the whole program analyzer and optimizer module 30 is configured to receive source and/or object code 20 and to create a whole program representation of received code. As used herein, a whole program representation is a representation of the various code segments that make up an entire computer program source code. In one embodiment, whole program analyzer and optimizer module 30 is configured to perform Inter-Procedural Analysis on the received code to create a whole program representation. Generally, whole program analysis techniques such as Inter Procedural analysis are powerful tools for parallelelization optimization and they are well known to those skilled in the art. It will be understood to one skilled in the art that other methods can also be employed to create a whole program representation of the received computer program source code.

In one embodiment, whole program analyzer and optimizer module 30 is also configured to perform parallelization techniques on the whole program representation. It will be understood to one skilled in the art that parallelization techniques can include employing standard data dependence characteristics of the program code under analysis. In a particular embodiment, whole program analyzer and optimizer module 30 is configured to perform automatic parallelization techniques. In an alternate embodiment, whole program analyzer and optimizer module 30 is configured to perform guided parallelization techniques based on user input received from a user through user interface 60.

In an alternate embodiment, whole program analyzer and optimizer module 30 is configured to perform automatic parallelization techniques and guided parallelization techniques based on user input received from a user through user interface 60. Thus, in a particular embodiment, whole program analyzer and optimizer module 30 can be configured to perform automatic parallelization techniques and/or to receive hints, suggestions, and/or other input from a user. Therefore, compiler 10 can be configured to perform foundational parallelization techniques, with additional customization and optimization from the programmer.

In particular, in one embodiment, compiler 10 can be configured to receive a single source file and apply automatically the same analysis techniques as it would for automatic parallelization in a homogeneous multiprocessing environment, to determine those regions of the program that can be parallelized, with additional input as appropriate from the programmer, to account for a heterogeneous multiprocessing environment. It will be understood to one skilled in the art that other configurations can also be employed.

Additionally, in one embodiment, whole program analyzer and optimizer module 30 can be configured to employ the results of the automatic and/or guided parallelization techniques in a whole program analysis. In particular, the results of the automatic and/or guided parallelization techniques are employed in a whole program analysis that examines data reference patterns and code characteristics to identify one or more optimal partitioning and/or parallelization strategy for the particular program. In one embodiment, whole program analyzer and optimizer module 30 is configured to apply the results automatically. In a particular embodiment, whole program analyzer and optimizer module 30 is configured to operate in a fully automated mode, which can be based on a variety of partitioning and/or parallelization strategies known to one skilled in the art.

In an alternate embodiment, whole program analyzer and optimizer module 30 is configured to employ the results to identify one or more optimal partitioning and/or parallelization strategies based on user input. In one embodiment, user input can include an acceptance or rejection of presented options, in a semi-automatic mode of operation. In an alternate embodiment, user input can include user-directed partitioning and/or parallelization strategies. Thus, compiler 10 can be configured to free the application programmer from managing the complex details of the architecture, while allowing for programmer control over the final partitioning and/or parallelization strategy. It will be understood to one skilled in the art that other configurations can also be employed.

Additionally, whole program analyzer and optimizer module 30 can be configured to annotate the whole program representation in light of the applied parallelization techniques and/or received user input. In an alternate embodiment, whole program analyzer and optimizer module 30 can also be configured to identify and mark loops or loop nests within the program that can be parallelized. Thus, whole program analyzer and optimizer module 30 can be configured to incorporate parallelization techniques, whether automated and/or based on user input, into the whole program representation, as embodied in annotations and/or marked segments of the whole program.

Compiler 10 also includes parallelization partitioning module 40. Parallelization partitioning module 40 is a circuit or circuits or other suitable logic and is configured, generally, to analyze the annotated whole program representation under a cost/benefit rubric, to partition the program based on the cost/benefit analysis, to partition identified parallel regions into subroutines and to compile the subroutines for the target node on which the particular subroutine is to execute. Thus, in a particular embodiment, parallelization partitioning module 40 is configured to analyze other code characteristics that could affect the partitioning and/or parallelization strategy of the program. It will be understood to one skilled in the art that other code characteristics can include the number or complexity of code branches and/or commands, data reference patterns, system accesses, local storage capacities, and/or other code characteristics.

Additionally, parallelization partitioning module 40 can be configured to generate a cost model of the program based on the annotated whole program representation and the cost/benefit rubric analysis. In a particular embodiment, generating a cost model of the program can include analyzing data reference patterns within and/or between identified loop, loop nests, and/or functions, as will be understood to one skilled in the art. In an alternate embodiment, generating a cost model of the program can include an analysis of other code characteristics that can influence the decision whether to execute one or more identified parallel regions on one or another particular node or processor type within the heterogeneous multiprocessing environment.

Additionally, parallelization partitioning module 40 is also configured to perform a cost/benefit analysis of the cost model of the annotated whole program representation. In one embodiment, performing a cost/benefit analysis includes applying a data transfer heuristic to further refine the identification of parallelizable program segments. As input to the data transfer heuristic, parallelization and partitioning module 40 will consider the memory reference information within and between parallelizable loops or regions, to determine a partitioning that minimizes data transfer cost by maintaining data locality and computational intensity within a said region. It will be understood to one skilled in the art that the cost/benefit analysis can include estimating the number of iterations a particular loop or loop nest will likely make, whether made by one or more discrete heterogeneous processing units, and determining whether the benefits of parallelizing the particular loop or loop nest exceed the timing, transmission, and/or power costs associated with parallelizing the particular loop or loop nest. It will be understood to one skilled in the art that other configurations can also be employed.

Parallelization partitioning module 40 can also be configured to modify the program code based on the cost/benefit analysis. In one embodiment parallelization partitioning module 40 is configured to modify the program code automatically, based on the cost/benefit analysis. In an alternate embodiment, parallelization partitioning module 40 is configured to modify the program code based on user input received from a user, which can be received in response to queries to the user to accept code modifications based on the cost/benefit analysis. In an alternate embodiment, parallelization partitioning module 40 is configured to modify the program code automatically, based on the cost/benefit analysis and user input. It will be understood to one skilled in the art that other configurations can also be employed.

Parallelization partitioning module 40 is also configured to compile received source and/or object code into one or more processor-specific backend code segments, based on the particular processing node on which the compiled processor-specific backend code segments are to execute, the “target” node. Thus, processor-specific backend code segments are compiled for the node-specific functionality required to support the particular functions embodied within the code segments, as optimized by the parallelization techniques and cost/benefit analysis.

In a particular embodiment, parallelization partitioning module 40 is configured to walk the annotated whole program representation to generate outlined procedures from those sections of the code determined to be profitably parallelizable, as will be understood to one skilled in the art. The outlined procedures can be configured to represent, for example, the code segments that will execute on parallel processors of the heterogeneous multiprocessing system, as well as appropriate calls to the data transfer commands and/or instructions to be executed in one or more of the other processors of the heterogeneous multiprocessing system. The resulting program segments, which can include multiple sub-procedures in intermediate program format, can be compiled to the instruction or object format of the respective execution processor. The compiled segments can be input to a program loader, for combination with the remaining uncompiled program segments, if any, to generate an executable program that appears as a single executable program. It will be understood to one skilled in the art that other configurations can also be employed.

Accordingly, compiler 10 can be configured to automate certain time-intensive programming activities, such as identifying and partitioning profitably parallelizable program code segments, thereby shifting the burden from the human programmer who would otherwise have to perform the tasks. Thus, compiler 10 can be configured to partition computer program code for parallelization in a heterogeneous multiprocessing environment, compiling particular segments for a particular type of target node on which they will execute.

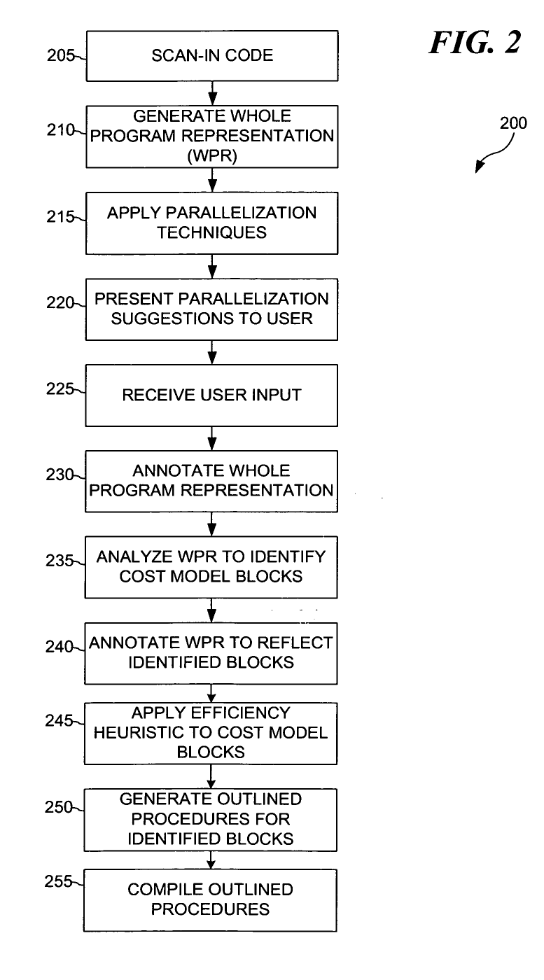

Referring to FIG. 2 of the drawings, the reference numeral 200 generally designates a flow chart depicting a computer program parallelization and partitioning method. The process begins at step 205, wherein computer program code to be analyzed is received or scanned in. This step can be performed by, for example, a compiler front end module 20 and/or object file reader module 25 of FIG. 1. It will be understood to one skilled in the art that receiving or scanning in code to be analyzed can include retrieving data stored on a hard drive or other suitable storage device and loading the data into a system memory. Additionally, in the case of the compiler front end, this step can also include parsing a source language program and producing an intermediate form code. In the case of object file reader module 25, this step can include extracting an intermediate representation from an object code file of the computer program code.

At next step 210, a whole program representation is generated based on received computer program code. This step can be performed by, for example, whole program analyzer and optimizer module 30 of FIG. 1. This step can include conducting Inter Procedural Analysis, as will be understood to one skilled in the art. At next step 215, parallelization techniques are applied to the whole program representation. The parallelization analysis will be either user directed, that is, incorporating pragmas commands indicating loops or program sections which can be executed in parallel, or it may be fully automatic employing aggressive data dependence analysis at compile time. This step can be performed by, for example, whole program analyzer and optimizer module 30 of FIG. 1. This step can include employing standard data dependence analysis, as will be understood to one skilled in the art. The outcome of step 215 is a partitioning of the user program into regions that can potentially execute on parallel on the attached processors. Additionally, barriers to parallelization may be flagged for presentation to the user at the next step; these barriers may consist of dependence violations that can either inhibit parallelization, incur unnecessary data transfers, or require excessive synchronization and serialization. Other barriers to parallelization can also be in the form of statements/machine instructions or system calls that inhibit execution of the parallel region on the attached processor, which does not contain support for such an operation.

At next step 220, parallelization suggestions can be presented to a user for user input. This step can be performed by, for example, whole program analyzer and optimizer module 30 and user interface 60 of FIG. 1. At next step 225, user input is received. This step can be performed by, for example, whole program analyzer and optimizer module 30 and user interface 60 of FIG. 1. It will be understood to one skilled in the art that this step can include parallelization suggestions accepted and/or rejected by the user.

At next step 230, the whole program representation is optionally annotated based on the optionally received user input, to reflect the updated parallelizable regions. This step can be performed by for example, whole program analyzer and optimizer module 30 of FIG. 1. At next step 235, the annotated whole program representation is further analyzed to determine the cost effectiveness of executing said identified parallelizable regions on the parallel attached processors. This step may include analyses of the processor type, as in a purely functional partitioning, but may additionally extend these analyses to include instruction sequences which contain excessive scalar references, branch instructions or other types of code which perform poorly, or are unsupported on the attached parallel processors. A further input to the cost model at this point will be the determination as to whether or not the decision to execute the said section in serial will result in the parallel processors remaining idle until the next profitable parallel section is encountered. This step can be performed by, for example, parallelization partitioning module 40 of FIG. 1. This step can include analyzing data reference patterns and other code characteristics to identify codes segments that might be profitably parallelizable, as described in more detail above.

At next step 240, the whole program representation is annotated to reflect identified cost model blocks. This step can be performed by, for example, parallelization partitioning module 40 of FIG. 1. At next step 245, an efficiency heuristic is applied to the cost model blocks. This step can be performed by, for example, parallelization partitioning module 40 of FIG. 1. It will be understood to one skilled in the art that an efficiency heuristic can include a cost/benefit heuristic, a data transfer heuristic, and/or other suitable rubric for cost/benefit analysis, as described in more detail above. This step can include-identifying and marking those segments that can be profitably parallelizable, as described in more detail above. This step can also include modifying the program code to include instructions to transfer code and/or data between processors as required, and instructions to check for completion of partitions executing on other processors and to perform other appropriate actions, as will be understood to one skilled in the art.

At next step 250, outlined procedures for identified cost model blocks that can be profitably parallelized are generated. This step can be performed by, for example, parallelization partitioning module 40 of FIG. 1. At next step 255, the outlined procedures are compiled to generate processor specific code for each cost model block that has been identified as profitably parallelizable, and the process ends. This step can be performed by, for example, parallelization partitioning module 40 of FIG. 1. It will be understood to one skilled in the art that this step can also include compiling the remainder of the program code, combining the resultant back end code into a single program, and generating a single executable program based on the combined code.

Thus, a computer program can be partitioned into parallelizable segments that are compiled for a particular node type, with sequencing modifications to orchestrate communication between various node types in the target system, based on an optimization strategy for execution in a heterogeneous multiprocessing environment. Accordingly, computer program code designed for a multiprocessor system with disparate or heterogeneous processing elements can be optimized in a manner similar to computer program code designed for a homogeneous multiprocessor system, and configured to account for certain functions that are required to be executed on a particular type of node. In particular, exploitation of the multiprocessing capabilities of heterogeneous systems is automated or semi-automated in a manner that exposes this functionality to program developers of varying skill levels.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for computer program code parallelization and partitioning for a heterogeneous multi-processor system, comprising:
receiving a collection of one or more source files referred to as a Single Source comprising data reference patterns and code characteristics;
applying parallelization analysis techniques to the received one or more source files;
identifying parallelizable regions of the received one or more source files based on applied parallelization analysis techniques;
analyzing the data reference patterns and code characteristics of the identified parallel regions to generate a partitioning strategy such that instances of the partitioned objects may execute in parallel;
inserting data transfer calls within the partitioned objects;
inserting synchronization where necessary to maintain correct execution;
partitioning the single source file based on the partitioning strategy; and
generating at least one heterogeneous executable object.

2. The method as recited in claim 1, wherein generating the partitioning strategy is automated.

3. The method as recited in claim 1, wherein generating the partitioning strategy is based on static user directives.

4. The method as recited in claim 1, wherein generating the partitioning strategy is based on static and dynamic user input

5. The method as recited in claim 1, wherein generating the partitioning strategy is automated and based on static and dynamic user input.

6. The method as recited in claim 1, further comprising generating a whole program representation.

7. The method as recited in claim 6, wherein generating a whole program representation comprises inter procedural analysis.

8. The method as recited in claim 1, wherein analyzing the data reference patterns and code characteristics comprises:
generating a cost model based on the data reference patterns within and between identified parallel regions
refining the cost model based on code characteristics of the identified parallel regions; and
applying a data transfer heuristic to the cost model.

9. The method as recited in claim 1, further comprising outlining the identified parallel regions into unique functions.

10. The method as recited in claim 9, further comprising compiling the outlined functions for the attached processors.

11. The method as recited in claim 1, further comprising compiling non-outlined functions for the main processor.

12. The method as recited in claim 8, further comprising generating a single executable program based on the compiled outlined and main functions.

13. A computer program product for computer program code parallelization and partitioning for a heterogeneous multi-processor system, comprising:
computer program code for receiving a collection of one or more source files referred to as a Single Source comprising data reference patterns and code characteristics;
computer program code for applying parallelization analysis techniques to the received one or more source files;
computer program code for identifying parallelizable regions of the received one or more source files based on applied parallelization analysis techniques;
computer program code for analyzing the data reference patterns and code characteristics of the identified parallel regions to generate a partitioning strategy such that instances of the partitioned objects may execute in parallel;
computer program code for inserting data transfer calls within the partitioned objects;
computer program code for inserting synchronization where necessary to maintain correct execution;
computer program code for partitioning the single source file based on the partitioning strategy; and
computer program code for generating at least one heterogeneous executable object.

14. The product as recited in claim 13, wherein generating the partitioning strategy is automated.

15. The product as recited in claim 13, wherein generating the partitioning strategy is based on static user directives.

16. The product as recited in claim 13, wherein generating the partitioning strategy is based on static and dynamic user input

17. The product as recited in claim 13, wherein generating the partitioning strategy is automated and based on static and dynamic user input.

18. The product as recited in claim 13, further comprising computer program code for generating a whole program representation.

19. The product as recited in claim 18, wherein generating a whole program representation comprises inter procedural analysis.

20. The product as recited in claim 13, wherein computer program code for analyzing the data reference patterns and code characteristics comprises:
computer program code for generating a cost model based on the data reference patterns within and between identified parallel regions
computer program code for refining the cost model based on code characteristics of the identified parallel regions; and
computer program code for applying a data transfer heuristic to the cost model.

21. The product as recited in claim 13, further comprising computer program code for outlining the identified parallel regions into unique functions.

22. The product as recited in claim 21, further comprising computer program code for compiling the outlined functions for the attached processors.

23. The product as recited in claim 13, further comprising computer program code for compiling non-outlined functions for the main processor.

24. The product as recited in claim 23, further comprising computer program code for generating a single executable program based on the compiled outlined and main functions.
